(19) United States
(12) Patent Application Publication
(10) Pub. No.: US 2020/0193504 A1
(43) Pub. Date: Jun. 18, 2020

(54) System and method for connected meal planning and connected meal presentation

(71) Applicants: Robert Alan Buckingham, Bend, OR (US); Thérèse Buckingham, Bend, OR (US); Carl Burnham, IV, Arlington, VA (US); Charles Quinn, Portland, OR (US)

(72) Inventors: Robert Alan Buckingham, Bend, OR (US); Thérèse Buckingham, Bend, OR (US); Carl Burnham, IV, Arlington, VA (US); Charles Quinn, Portland, OR (US)

(21) Appl. No.: 16/350,628

(22) Filed: Dec. 12, 2018

(51) Int. Cl. G06Q 30/06

(52) U.S. Cl. CPC G06Q 30/0633

(57) ABSTRACT

The invention relates to a system and method for planning and presenting recipes for meals during a planning period. More particularly, the invention provides a method of connected meal planning and connected meal presentation based on grouping meal recipes for a planning period on the initial selection of a single meal, with a list of remaining meal choices and corresponding recipes based on individual or shared ingredients, whether raw or prepared, and forecasted cooking day. The invention provides a presentation system for ingredients and calculated quantities used in a later distinct recipe during a planning period which includes previously prepared food items or prepared ingredients. The invention also provides a presentation system for calculating total raw ingredient quantities to be used for purchase.

### CROSS REFERENCE TO RELATED REFERENCES

This application claims benefit under Title 35, United States Code, Section 119(e) of U.S. provisional patent application No. 62/596,778, December 2017. This application is a continuation of the No. 62/596,778 application. The No. 62/596,778 application is hereby incorporated by reference into this application.

### BACKGROUND OF THE INVENTION

### Field of the Invention

The present invention relates to a system and method for planning and presenting recipes for meals. More particularly, the present invention provides a method of connected meal planning and connected meal presentation based on grouping meal recipes for a planning period on the initial selection of a single meal, with a list of remaining meal choices and corresponding recipes based on individual or shared ingredients, whether raw or prepared, and forecasted cooking day and the presentation of a later distinct recipe during a planning period which includes previously prepared food items or prepared ingredients.

### Description of the Related Art

Many tools and applications exist to assist users in planning or scheduling meals and corresponding recipes for a forecasted time period. For example, U.S. Pat. No. 9,576,034 to Kamei et al.; U.S. Pat. No. 9,552,461 to Harrison; U.S. Pat. No. 5,960,440 to Brenner et. al. all are illustrative of such prior art.

However, these existing tools and applications generally operate by optimizing for the nutritional or fitness goals of users, or by optimizing for user preference or convenience by allowing specific user inputs or search requests. Tools and applications may enable users to meet nutritional or fitness goals by adjusting serving sizes of recipes, calculating calories for recipes or meal plans, or presenting only recipes meeting particular dietary criteria or satisfying particular dietary restrictions.

Kamai et al, (U.S. Pat. No. 9,576,034) recognized that a single prepared meal may comprise a plurality of dishes, with each dish intended for consumption by particular family member in order to accommodate food allergies or restrictions.

Harrison (U.S. Pat. No. 9,552,461) discloses a system and method for preparing food, involving a nutritional information module for aggregating nutritional and portion information of an entire menu to adjust serving weight by caloric value. It also includes a scheduler module whereby the user may create a menu and add recipes to create multiple course meals, and which compiles task information for any individual recipe.

Existing tools and applications may also optimize for specific user preferences or convenience, such as by filtering recipes by available ingredients, desired cooking methods, or amount of preparation time. In terms of scheduling meals, existing tools and applications often rely on a user's selection of each recipe for the forecasted time period as well as the user's selection of the order in which the recipes will be prepared.

Brenner et al, (U.S. Pat. No. 5,960,440) discloses a method of scaling recipes by providing a main recipe and at least one sub recipe having a predetermined scaled ingredient quantities and preparation instructions. It also discloses generating shopping lists for a dish or meal, for one or more days or a week, by data entry through a keyboard or by selecting recipes and/or specific ingredients from recipes.

Still another limitation of existing tools and applications is that recipes may be limited to the individual dishes that may be part of a complete meal; for example, an entrée or main dish, a side dish, and a dessert may all be part of the same meal, but are displayed as separate recipes apart from each other with no predetermined connection.

### BRIEF DESCRIPTION OF THE INVENTION

Although these existing tools and applications for meal planning may enable users to customize many aspects of an individual meal plan, the planning and preparation of such meals may still be time consuming and inconvenient for a number of reasons: users must still make all decisions regarding which recipes to include in meal plan and in what order, user-selected recipes for the meal plan may not share ingredients, user-selected recipes for the meal plan may not be selected or sequenced to minimize overall preparation and cook time, etc. Conventional meal planning tools and applications may enable users to create highly customized meal plans to account for personal preferences or nutritional goals, but these conventional meal planning tools and applications fail to provide shortcuts or a way of streamlining the user's decision-making and the food preparation processes in order to minimize time and waste.

This patent discloses and claims a useful, novel, and unobvious invention for a system and method for connected meal planning and connected meal presentation, which saves the user time and effort to prepare meals in the planning period.

The present invention provides a method of grouping meal recipes for a planning period based on the initial selection of a single core meal, with a list of remaining meal choices and corresponding recipes based on individual or shared ingredients, whether raw or prepared, and forecasted cooking day. The connected meal planning system includes: a measurement database storing cooking and shopping units; a conversion database storing cooking and shopping unit equivalencies; an ingredient database storing ingredient information; a meal database storing a collection of ingredients and meal descriptions, both prepared and raw, their quantities, and preparation and cooking steps; and a connected meal database that stores the connected meal descriptions, meal groupings and selection sequencing.

Connected meal plans and their associated core meals are presented to the user, who selects one connected meal plan or core meal to begin the planning period. Users are then presented with a list of remaining meal choices and corresponding recipes based on individual or shared ingredients, whether raw or prepared, and forecasted cooking day.

The connected meal presentation system also provides a method for calculating a shopping quantity from a recipe quantity using number of servings, raw ingredients, and ingredients that contain previously processed ingredients which forms a new prepared ingredient, converted to a new measurement which may be adjusted based on optional rounding or shopping ingredient limiters. The present invention also provides a method for presenting recipe instructions to include storage of prepared ingredients or previously prepared food items to be used in a later distinct recipe during a planning period.

### BRIEF DESCRIPTION OF THE DRAWINGS

The above and other features of this invention are described in the following Detailed Description and shown in the following drawings:

FIG. 1 illustrates a computer network that provides a system in accordance with an exemplary embodiment of the invention;

FIG. 2 illustrates hardware component configuration of the connected meal system in accordance with an exemplary embodiment of the invention;

FIG. 3 illustrates a flow diagram of process of the connected meal system in accordance with an exemplary embodiment of the invention;

FIG. 4 illustrates a flow diagram of creating a measurement in accordance with an exemplary embodiment of the invention;

FIG. 5 illustrates a flow diagram of creating a conversion in accordance with an exemplary embodiment of the invention;

FIG. 6 illustrates a flow diagram of creating an ingredient in accordance with an exemplary embodiment of the invention;

FIG. 7 illustrates a flow diagram of creating a meal in accordance with an exemplary embodiment of the invention;

FIG. 8 illustrates a flow diagram of creating a connected meal plan in accordance with an exemplary embodiment of the invention;

FIG. 9 illustrates a flow diagram of creating a personal meal plan in accordance with an exemplary embodiment of the invention;

FIG. 10 illustrates a flow diagram of creating a personal shopping list in accordance with an exemplary embodiment of the invention;

FIG. 11 illustrates a flow diagram of displaying recipe instructions in accordance with an exemplary embodiment of the invention.

### DETAILED DESCRIPTION (OF THE PREFERRED EMBODIMENTS)

Reference will now be made to the figures listed above. It is understood that the figures are diagrammatic and schematic representations of exemplary embodiments of the present invention, and are neither limiting nor necessarily drawn to scale. For clarity it is to be understood that the words “including,” “has” and “having,” as used herein shall have the same meaning as the word “comprising.” These diagrams are provided in accordance with an exemplary embodiment of the invention and should not be construed to limit other embodiments within the scope of the invention, but rather to enable any person skilled in the art to make and use the invention.

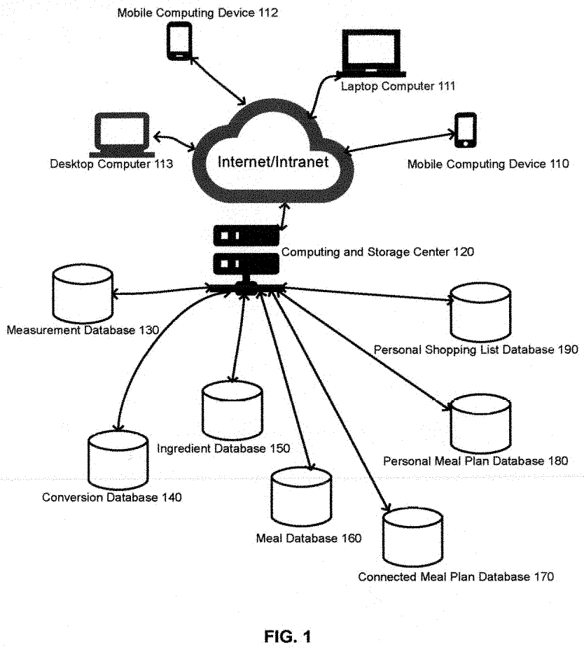

FIG. 1 illustrates a global computer network 100 such as the Internet or Intranet that connects various processing systems in network 100 to allow the exchange of data between the processing systems. One skilled in the art will recognize that processing systems are desktop 113 and laptop computers 111, mobile computing devices 110, computing servers or other devices that can process digital data.

Computing and storage center 120 is a processing device that controls data transfers between processing systems connected to Internet/Intranet 101. Computer and storage center 120 also contains measurement database 130, conversion database 140, ingredient database 150, meal database 160, connected meal plan database 170, personal meal plan database 180, and personal shopping list database 190.

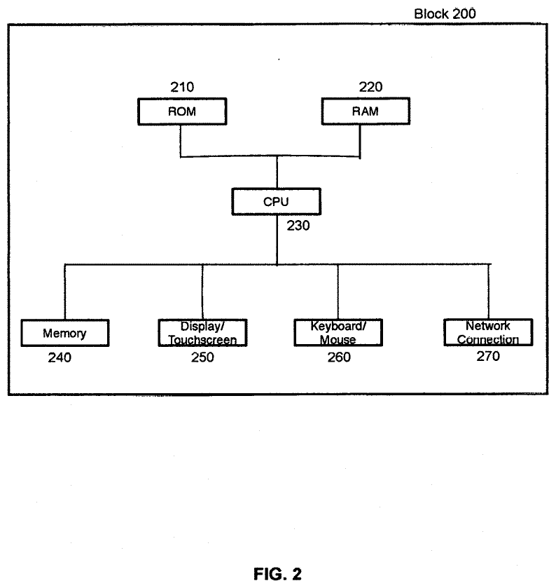

FIG. 2 shows an exemplary hardware configuration of a connected meal presentation system Block 200 according to an embodiment. As shown in FIG. 2, example user input can be from touchscreen display 250 and keyboard/mouse 260. Central processing unit (CPU) 230 represents hardware which executes a control program of the connected meal presentation system. It receives and sends data from ROM 210, RAM 220, and Memory 240. Network Connection 270 may receive and send data to Computing and Storage Center 120 shown on FIG. 1.

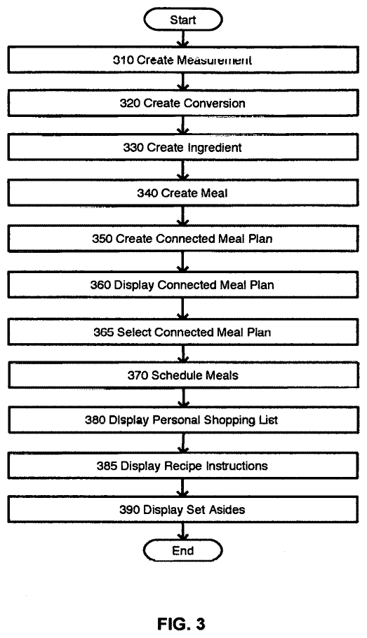

FIG. 3 illustrates the system flow for connected meal planning and connected meal presentation. The first step is Create Measurement 310, followed by Create Conversion 320, then Create Ingredient 330, Create Meal 340 and Create Connected Meal Plan 350. Display Connected Meal Plan 360 allows users to Select Connected Meal Plan 365 and Schedule Meals 370. The Display Personal Shopping List 380, Display Recipe Instructions 385 and Display Set Asides 390 complete the flow. Each of these major steps are detailed below.

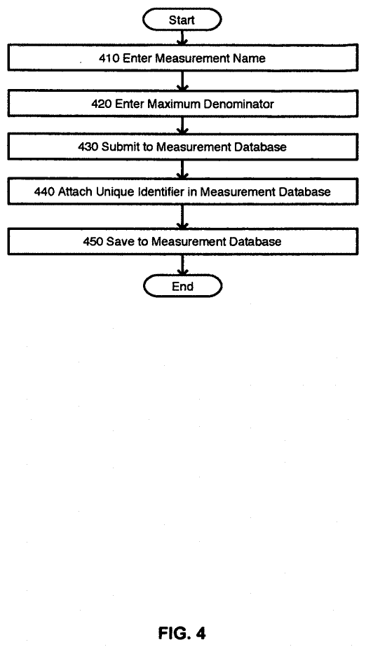

FIG. 4 is a flowchart showing the data fields and processing to be performed for Create Measurement. Measurement Name 410 is entered as is Maximum Denominator 420. The user Submits to Measurement Database 430. Measurement Database (FIG. 1, 130) Attaches Unique Identifier 440 and Saves to Measurement Database 450. Example measurement names include: pound, each, medium, ounce, cup, etc. Maximum denominator values include whole numbers greater than or equal to 1.

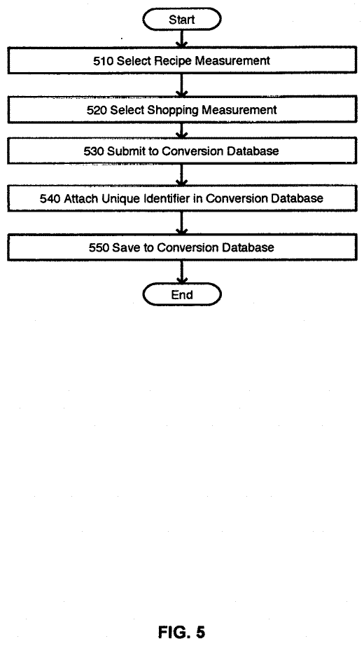

FIG. 5 is a flowchart showing the creation of a conversion. Conversions are used to adjust recipe ingredient quantities to shopping quantities and also to convert raw ingredient quantities to prepared ingredient quantities. The user starts with Select Recipe Measurement 510 and Select Shopping Measurement 520. Numerators, in whole number format, for each arc entered. The user Submits to Conversion Database 530. Measurement Database (FIG. 1, 140) Attaches Unique Identifier 540 and Saves to Conversion Database 550. Example conversions include: 1 cup=½ medium, or ¼ cup=2 ounces.

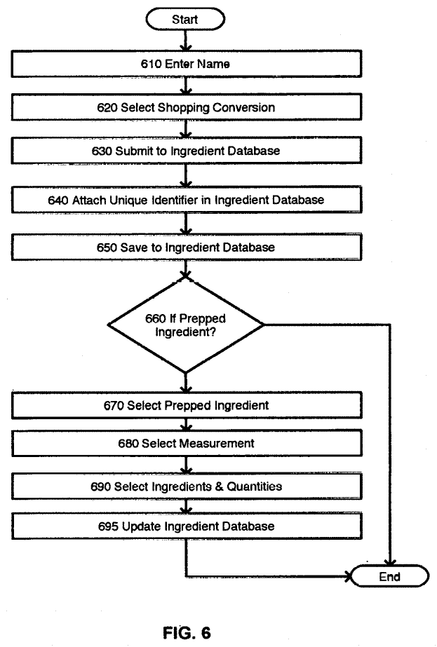

FIG. 6 is an illustrated embodiment to create an ingredient that is stored in the Ingredient Database FIG. 1, 150. Ingredient fields include Name and Shopping Conversion. Example ingredients may include an unwashed head of lettuce, uncooked brown rice, or uncooked meat. A user starts by Enter Name 610, creating a name for the ingredient. The user then Selects Shopping Conversion 620 to associate a conversion from Conversion Database (FIG. 1, 140) to that ingredient. The user Submits to Ingredient Database 630. Ingredient Database (FIG. 1, 150) Attaches Unique Identifier 640 and Saves to Ingredient Database 650 complete the process of ingredients.

Raw ingredients may be identified by various criteria, including but not limited to their recipe-to-shopping conversions and possible units of measurement. Prepped ingredients may also be identified by various criteria, including but not limited to prepped-to-raw ingredient conversions. Conversion keys for the prepped-to-raw ingredient conversions may rely upon several factors, including but not limited to the quantity of prepped ingredient available from a previously prepared recipe in a given planning period, the prepped unit of measurement, and inputs such as an ingredient key, quantity, or unit of measurement key.

Additional steps are performed if the ingredient is a prepared ingredient. Prepped ingredients have been modified by the user in some way in preparation or cooking steps of a prior meal in the planning period. Examples of user modifications may include, but are not limited to: washing, crushing, cutting, tearing, or cooking. A user will Select Prepped Ingredient 670 from the list of existing named ingredients, Select Measurement 680 from measurements associated with said ingredient, then Select Ingredients and Quantities 690 adding ingredients to the composition list of the prepped ingredient. The user then Update Ingredient Database 695 to save the prepped ingredient information.

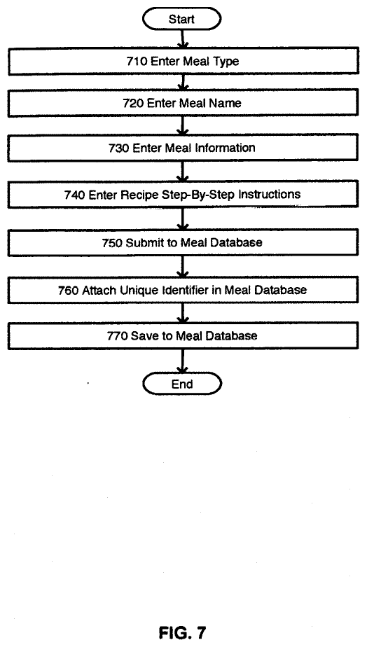

FIG. 7 is an illustrated embodiment of the steps required to create a meal (a recipe) in the Meal Database (FIG. 1, 160). The system utilizes a meal database (or recipe database) as the source of recipes available for selection in the connected meal system. Each record in the meal database includes the necessary ingredients, quantities and characteristics of ingredients, tools, steps, and notes for preparation of a given meal. The user starts by Enter Meal Type 710 and Enter Meal Name 720. Examples of meal type can include but are not limited to: Core Meal, Fresh Dinner, Carryout. Additional meal descriptions can be added in Enter Meal Information 730. Step-by-Step Instructions are entered in step 740 with all entered data submitted to the meal database in step 750. Meal Database (FIG. 1, 160) Attaches Unique Identifier 740 and Saves to Meal Database 770.

Core meals of the connected meal system may be identified by various criteria, including but not limited to: the core meal's included meals (for example, a core meal's carryout or any fresh dinners associated with the core meal), core meal ingredients, and recipe instructions. The “included meals” criteria allows for the core meal to be identified by its connection to particular fresh dinners or carryouts. Additionally, ingredients for a core meal may be identified by an ingredient key, a quantity, and a unit of measurement key. Core meal recipes may be further identified by their particular preparation steps (such as by particular instructions).

Fresh dinners and carryouts of the connected meal system may also be identified by various criteria, including but not limited to: ingredients and recipe instructions. Ingredients for fresh dinners and carryouts may also be identified by an ingredient key, quantity, and unit of measurement key. Recipes for fresh dinners and carryouts may be further identified by their particular preparation steps (such as by particular instructions).

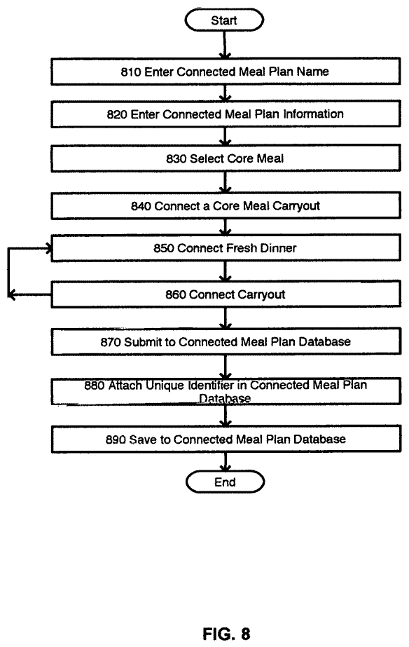

FIG. 8 illustrates the creation of a connected meal plan (also “connected meal system” or “system”). A connected meal plan is a grouping of meals, not individual dishes, that have been designed using shared ingredients and, when sequenced in a planning period, minimizes a user's overall preparation and cooking time. Connected meal plans are stored in the connected meal plan database FIG. 1, 170.

To create a connected meal plan, the user first Enter Connected Meal Plan Name 810, and other meal plan descriptors in Enter Connected Meal Plan Information 820. The user then performs Select Core Meal 830 choosing only one core meal. Connect a Core Meal Carryout 840 may be performed next. Select Fresh Dinner 850, Select Carryout 860 are performed until enough fresh dinner and carryout meals are selected to cover the planning period. All entered data is submitted to the Connected Meal Plan Database in step 870. The Connected Meal Plan Database (FIG. 1, 170) Attaches Unique Identifier 880 to each selected meal and Saves to Connected Meal Plan Database 890, completing the creation of a connected meal plan.

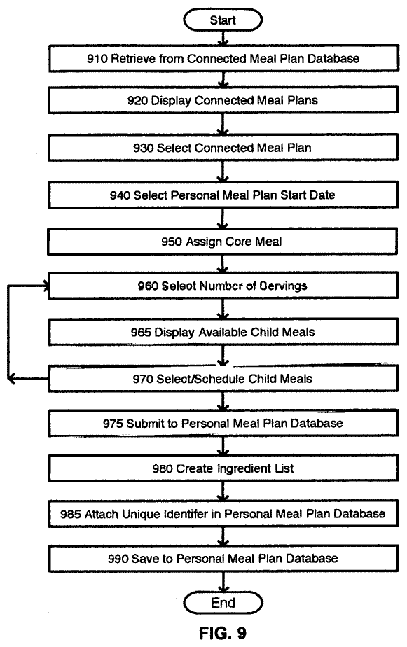

The connected meal system incorporates the creating of a Personal Meal Plan from the display of a connected meal plan. FIG. 9 is an illustrated embodiment of the steps required to create a Personal Meal Plan which is stored in the Personal Meal Plan Database (FIG. 1, 180). A computing device as described in FIG. 2, retrieves connected meal plans (910) from the Connected Meal Plan Database (FIG. 1, 170) and Display Connected Meal Plans 920 on said device. The user Selects Connected Meal Plan 930 and begins the meal plan customization process in Select Personal Meal Plan Start Date 940. By selecting a connected meal plan the core meal is assigned (950) as the first meal made by the user in the planning period, beginning on the start date entered. A user's selection for meal plan start date may precede a user's selection of a core meal recipe, but this is not required. Users may select start date by weekday or by a more specific combination of month, day, or year. The user can optionally enter number of servings for any meal (960) throughout the customization process.

The connecting of meals, for example: core meal to carryout, core meal to fresh dinner, fresh dinner to carryout, when added to a users personal meal plan schedule creates sequential filtering which allows the system to provide instructions to the user for minimizing overall preparation time and waste of ingredients. The instructions given for a selected core meal may instruct the user to prepare an extra amount of one or more ingredients than what is required for the current recipe so that the user can save time later during the planning period where another recipe may require the same prepped ingredient. Alternatively, the instructions for a selected core meal may also instruct a user to prepare one or more ingredients that will not be used in the current recipe. Such instruction may make use of any wait times that a user may experience during cooking of the current recipe so that the user can save time later during the planning period where another recipe will require the prepped ingredient.

The user's selection of a core meal or its associated connected meal plan provides a filter for the presentation of available fresh dinners and carryouts (Display Available Child Meals 965) and from the Meal Database (FIG. 1. 160) utilizing its unique identifier saved in the connected meal plan database (FIG. 1, 170). Additionally, the selection of a fresh dinner may also provide a filter for the presentation of available carryouts. Upon selection and scheduling of desired remaining meals (Select/Schedule Child Meals 970) listed in the connected meal plan, the user Submit to Personal Meal Plan Database 975.

The Connected Meal System then creates at step 980, an Ingredient List (or parent list) for each meal selected, identifying the total quantity of raw ingredients used by each meal. The Personal Meal Database (FIG. 1, 180) Attaches Unique Identifier 985 and saves all information, including the Ingredient list and quantities for each meal, in step 990.

In addition to recipe curation and listings of ingredients and instructions, the connected meal system also includes various calculation engines to compute the recipe and shopping quantities needed for the planning period, and more specifically for each meal and future meal in the planning period.

The recipe ingredient calculation engine may compute the total quantities needed for the entire connected meal plan for all raw and prepped ingredients by breaking down all prepped ingredients to their raw ingredient components, and may also compute the unique quantities required for each recipe in the connected meal plan. The unique quantities of ingredients for each recipe may vary depending on the number and type of fresh dinners, carryouts, leftovers, and number of servings selected for each by the user for a given planning period. The initial or starting quantity for any ingredient of a recipe in the connected meal plan may be determined from the value present in the recipe database for the connected meal plan system. By utilizing a forward-looking approach, the connected meal plan system may identify all uses of a particular ingredient as well as any prepped ingredient that may contain it. Based on these future uses and servings, the system may display the amount needed to be cooked within the base recipe.

The Ingredient List is calculated by:
1) For each meal, multiplying each ingredients' quantity by the number of servings selected for that meal;
2) For each meal, in reversed chronological order, add every prepped ingredient's raw inputs to the meal's Ingredient list.

For example, all ingredients of a selected core meal for a given planning period will necessarily be raw ingredients only. The starting quantity for any particular ingredient listed in a core meal recipe may be identified in the recipe database. These starting quantities for each core meal ingredient may be multiplied by the number of servings for the core meal designated by the user. Additionally, dynamic instructions may allow for the calculation and further display of the quantities for prepped ingredients originating from the core meal of a given planning period. The quantities of prepped ingredients for the selected core meal's corresponding carryout may be multiplied by any necessary conversion factor and the number of servings for the corresponding carryout designated by the user.

If a particular raw ingredient of the core meal is also part of a prepped ingredient used in a later recipe, then the quantities of prepped ingredients for each combination of fresh dinner and corresponding carryout may be calculated in a similar manner. The starting quantity for any particular ingredient listed in a fresh dinner recipe, whether raw or prepped, may be identified in the recipe database. These starting quantities for each fresh dinner ingredient may be multiplied by the number of servings for that particular fresh dinner as designated by the user. Dynamic instructions may allow for the calculation and further display of the quantities for prepped ingredients originating from the core meal or the particular fresh dinner designated by the user. The quantities of prepped ingredients for the selected fresh dinner's corresponding carryout may be multiplied by any necessary conversion factor and the number of servings for the corresponding carryout designated by the user.

The displayed ingredients for a fresh dinner may be raw ingredients, or prepped ingredients from the core meal. The starting quantity for any particular ingredient listed in a fresh dinner recipe may be identified in the recipe database. If a particular raw ingredient of the fresh dinner is also part of a prepped ingredient used in a later recipe, then the quantities of prepped ingredients for each combination of fresh dinner and corresponding carryout may be calculated in a similar manner. The starting quantities for each fresh dinner ingredient may be multiplied by the number of servings for that particular fresh dinner as designated by the user. Dynamic instructions may allow for the addition of prepped ingredients, whether originating from the core meal or any previously prepared fresh dinner. The quantities of prepped ingredients for the selected fresh dinner's corresponding carryout may be multiplied by any necessary conversion factor and the number of servings for the corresponding carryout designated by the user.

The displayed ingredients for a carryout may be raw ingredients, or prepped ingredients from the core meal, or prepped ingredients from the carryout's associated fresh diner. The starting quantity for any particular ingredient listed in a carryout recipe may be identified in the recipe database. The starting quantities for each carryout ingredient may be multiplied by the number of servings for that particular carryout as designated by the user.

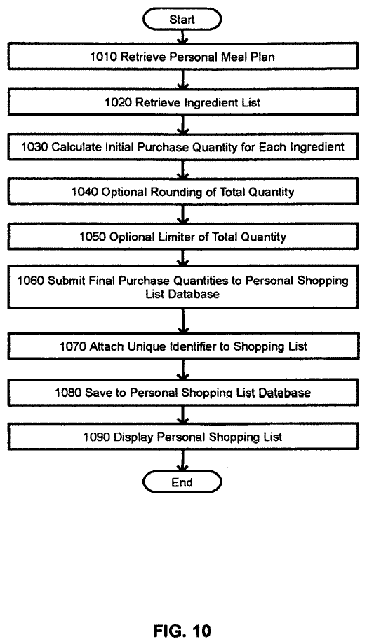

Total ingredients and quantities of the selected recipes may be converted to a shopping list. The personal shopping list displays the ingredients and corresponding quantities for all recipes in the planning period. FIG. 10 illustrates the creation of a Personal Shopping List. Beginning with Retrieve Personal Meal Plan 1010, the system Retrieve Ingredient List 1020 for each meal and begins Calculating Initial Purchase Quantity for Each Ingredient (step 1030) as follows:
1) For each meal, for each ingredient and beginning with prepped ingredients' raw inputs, add ingredient and quantity to the personal shopping list;
2) Continuing with non-prepped ingredients, append ingredient and quantity to personal shopping list, adding quantities together for items already on the shopping list;
3) Quantities can optionally be rounded up or down (Optional Rounding of Total Quantity 1050);
4) Quantities can optionally be divided by a maximum unit size (Optional Limiter of Total Quantity 1050).
   The latter two steps make it easier for the user to purchase ingredients in traditional stock keeping unit quantities.

Once each ingredients total shopping quantities for the Personal Meal Plan are computed, they are submitted to the Personal Shopping List Database (FIG. 1, 190) in step 1060. the database attaches a Unique Identifier to Shopping List 1070, saving all information to the database in step 1080. The system then displays the personal shopping list and computed quantities for the selected personal meal plan (step 1090).

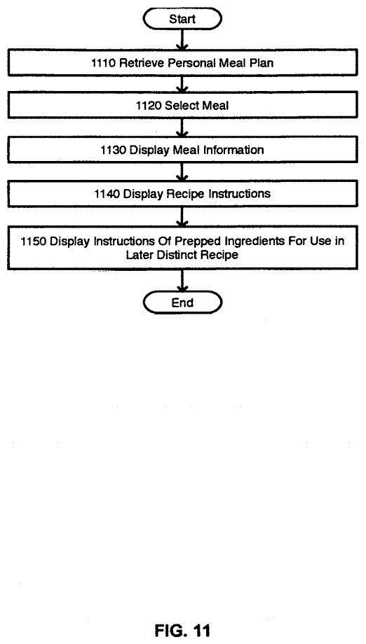

Connected meal presentation also involves the display of the individual meal recipes, step-by-step instructions and the quantities required for each ingredient. FIG. 11 illustrates the display of relevant information, including the quantities and ingredients of shared, prepped ingredients to be used in later, distinct meals scheduled in the planning period.

There are a variety of situations the connected meal system may encounter in which intelligent instructions may be displayed. The effectiveness of the connected meal planning system depends upon the utilization of the ingredients and coordination of ingredient preparation and storage. Instructions are paramount since these direct the user how and when to prepare and store ingredients to be used in future meals of a given planning period. The system may utilize an intelligent instruction system to coordinate meal preparation and storage. Instructions may be based on future meals selected by the user for the connected meal plan of a given planning period.

Categories of processes that may utilize intelligent instructions may include, but is not limited only to the following: carryout preparation, prepped ingredient storage, and leftover storage. In carryout preparation instructions, if a carryout is to be selected from a fresh dinner, the instructions to prepare particular prepped ingredients or even the entire carryout may be included in the instructions for the associated fresh dinner. In prepped ingredient storage instructions, if prepped ingredients that will be utilized later during the planning period are made for a particular meal, then the quantities for setting aside and storage instructions for use in future meals may be included in the instructions for that particular meal. In leftover storage instructions, if a leftover is selected for a particular meal, then the instructions to store the leftover may be included with the instructions for that particular meal.

Using a computing device as illustrated in FIG. 1, a user will retrieve their Personal Meal Plan (step 1110) and select the scheduled meal (step 1120) by a form of input available on the device. The connected meal system will display the meal information stored in the Personal Meal Database (FIG. 1, 180), in particular, displaying recipe instructions in sequential order along with associated ingredients and computed quantities (step 1140). The system also displays intelligent instructions (also referred to as “dynamic instructions”) and quantities of prepped ingredients required by future meals in the planning period (step 1150).

As any person skilled in the art will recognize from the previous description and from the figures and claims, modifications and changes can be made to the preferred embodiments of the invention without departing from the scope of the invention defined in the following claims.

1. A connected meal planning a presentation computer system comprising:
a user interface application configured to save information and instructions into measurement, conversion, ingredient, meal and connected meal plan databases;
a user interface application configured to save personal meal plans and meal schedules into the personal meal plan database for a planning period;
the hardware processor to initiate the creation and storage of an ingredient list in the personal meal plan database for said planning period;
the hardware processor to initiate the calculations and storage of purchase quantities in the personal shopping list database for said planning period;
a display configured to display the personal shopping list for said planning period;
a display configured to display the said personal meal plan and distinct meal information and recipe instructions which include prepped ingredients for use in later distinct meals within said planning period.

2. The connected meal planning system according to claim 1;
wherein the method of grouping meal recipes for a planning period is based on the initial selection of a single (core) meal,
with a display configured to display the presentation selection of recipes for user selection for said planning period that are determined by initial selection of a single (core) meal.

3. The connected meal planning system according to claim 1;
wherein the method of grouping meal recipes for a planning period by use of a previously prepared food dish or prepped ingredient,
with a display configured to display the presentation selection of recipes for user selection for said planning period that are determined by use of shared ingredients.

4. A connected meal presentation system according to claim 1,
wherein the method of presenting recipe instructions for a planning period comprise;
with a display configured to display the presentation of a preparation of previously prepared food items to be used in a later distinct recipe during said planning period,
with a display configured to display the presentation storage of previously prepared food items to be used in a later distinct recipe during said planning period.

5. A connected meal presentation system according to claim 1, further determining specific ingredient quantities using:
a calculation of total quantities of ingredients in grouping of meal recipes for a planning period;
a calculation of total raw ingredient quantities for a planning period with optional rounding to provide a purchase quantity;
a calculation of total raw ingredient quantities for a planning period with optional limiter function to provide a recommended shopping unit purchase quantity.
